(19) United States
(12) Patent Application Publication
(10) Pub. No.: US 2009/0301583 A1
(43) Pub. Date: Dec. 10, 2009

(54) SMALL ENGINE FUEL SYSTEM

(76) Inventors: Vaughn K. Mills, Chelsea, MI (US); Andrew W. Mclntosh, Ann Arbor, MI (US); Peter G. Belanger, Ann Arbor, MI (US)

Correspondence Address: JULIA CHURCH DIERKER;DIERKER & ASSOCIATES, P.C., 3331 W. BIG BEAVER RD. SUITE 109, TROY, MI, 48084-2813, US

(21) Appl. No.: 12/133,983

(22) Filed: Jun. 5, 2008

(51) Int. Cl. F16K 17/196

(52) U.S. Cl. 137/539; 137/512

(57) ABSTRACT

A small engine fuel system includes a vent valve configured to be disposed within a tank having at least a portion of a filler pipe defined therein. The filler pipe includes an upper portion configured to receive a fluid and a lower portion located at a predetermined depth in the tank, where the predetermined depth defines a liquid fill level of the tank. The small engine fuel system further includes spring valve arranged in series with the vent valve. The spring valve is configured to close during a refilling event, thereby substantially preventing overfill of the tank with the fluid.

### BACKGROUND

The present disclosure relates generally to small engine fuel systems.

Small engine fuel systems are often used in many, gas-powered devices such as, for example, power generating sets, garden tractors, lawn mowers, weed cutters, motorcycles, all-terrain vehicles, boats, small recreational transportation vehicles, and/or the like. The small engine fuel system may include a tank having a refilling inlet with a removable filler cap. These small engine fuel systems may be refilled by removing the filler cap and pouring fluid (e.g., fuel) from a portable fluid container. The fluid may be poured through a spout formed on the portable fluid container, or may be poured into the refilling inlet via a funnel. The fluid may also be transferred by a pump from a large tank to the small engine fuel system through a pipe via a nozzle.

Recently, fuel vapor emission requirements have been mandated on many fuel systems, including small engine fuel systems. These fuel vapor emission requirements generally regulate the amount of fuel vapors that may be emitted into the atmosphere when the fuel system is operating or when the fuel system is at rest. In some instances, fuel vapors may also be emitted into the atmosphere when the engine is not running such as, for example, during a refilling event.

### SUMMARY

A small engine fuel system includes a tank with at least a portion of a filler pipe defined in the tank. The filler pipe includes an upper portion configured to receive a fluid and a lower portion located at a predetermined depth in the tank, where the predetermined depth defines a liquid fill level of the tank. The small engine fuel system further includes a vent valve disposed within the tank and a spring valve arranged in series with the vent valve. The spring valve is configured to close during a refilling event, thereby substantially preventing overfill of the tank with the fluid.

### BRIEF DESCRIPTION OF THE DRAWINGS

Features and advantages of embodiment(s) of the present disclosure will become apparent by reference to the following detailed description and drawings, in which like reference numerals correspond to the same or similar, though perhaps not identical components. For the sake of brevity, reference numerals having a previously described function may or may not be described in connection with other drawings in which they appear.

FIG. 1 is a semi-schematic, cross-sectional view of a small engine fuel system;

FIG. 2 is a cross-sectional view of an embodiment of a spring valve during a mode of operation of the small engine fuel system of FIG. 1;

FIG. 3 is a cross-sectional view of an embodiment of a spring valve during another mode of operation of the small engine fuel system of FIG. 1; and

FIG. 4 is a cross-sectional view of an embodiment of a spring valve during yet another mode of operation of the small engine fuel system of FIG. 1.

### DETAILED DESCRIPTION

Embodiment(s) of the small engine fuel system as disclosed herein advantageously substantially prevent overfilling of a small engine fuel system tank with fluid during a refilling event. This may be accomplished by providing a spring valve in the system such that the spring valve is operatively arranged in series with a vent valve. The spring valve includes low-flow and high-flow fluid passages that close during the refilling event to substantially prevent the escape of vapors from inside the tank through the spring valve. It is to be understood that vapors inside the tank substantially cannot be displaced by rising liquid within the tank after the lower end of the filler pipe is covered by liquid, as such, additional refilling fluid cannot be added to the tank and, thus the tank cannot be overfilled. Prevention of overfilling of the tank may advantageously improve the operating performance of the small engine fuel system. For example, a vapor space is maintained to allow proper venting of a sealed fuel tank (where a refueling cap has been replaced) during engine running or rest conditions.

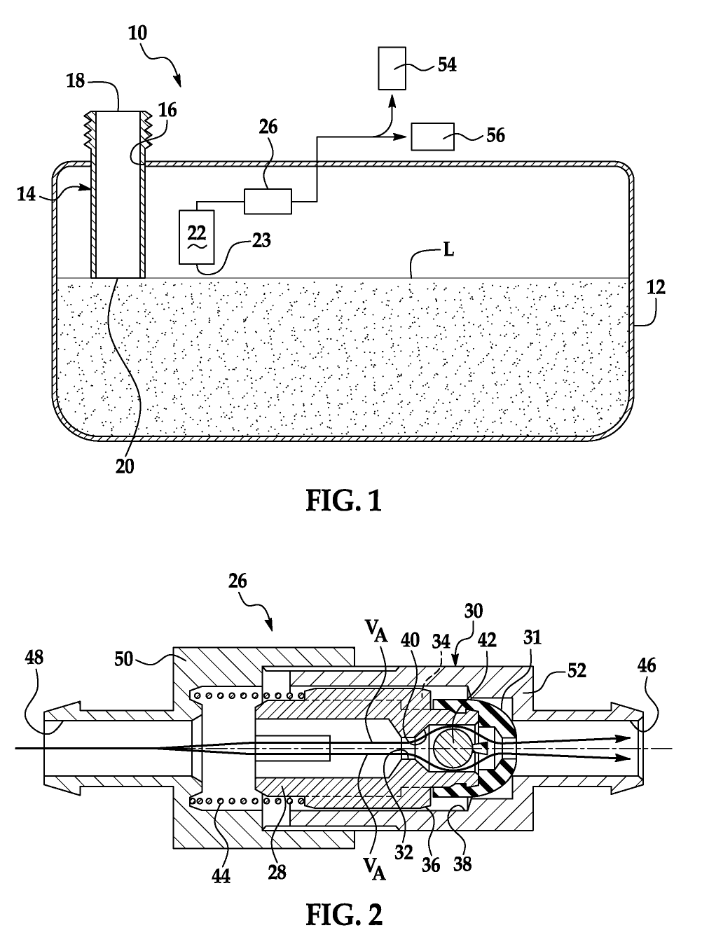

With reference to FIG. 1, an embodiment of the small engine fuel system 10 includes a tank 12 configured to retain a fluid therein, where the fluid may be liquid(s), vapor(s), or a combination of liquid(s) and vapor(s). It is to be understood that the liquid may be a single liquid material or a mixture of a plurality of liquid materials. Non-limiting examples of suitable liquids include gasoline, 2-cycle gasoline/oil mix, diesel, ethanol, and/or the like, and/or combinations thereof. Like the liquid, the vapor may also be a single vapor material or a mixture of a plurality vapor materials. Non-limiting examples of suitable vapors include gasoline vapor, diesel vapor, ethanol vapor, air, and/or the like, and/or combinations thereof.

The tank 12 may be a single-layered polymeric structure, a multi-layered polymeric structure, a steel structure, and/or other structures suitable for use in small engine fuel systems. A filler pipe 14 is at least partially disposed in the tank 12 via an opening 16 formed therein. The filler pipe 14 includes an upper portion 18 that is configured to receive the fluid during a refilling event, and further includes a lower portion 20 that extends into the tank 12 at a predetermined depth. The predetermined depth may be selected, at least in part, based on a desired depth of the liquid portion of the fluid to be retained in the tank 12, thereby defining a liquid fill level L of the tank 12. In a non-limiting example, the liquid portion of the fluid may fill the tank 12 up to the liquid fill level L during a refilling event, whereas the vapor portion of the fluid (if any) enters an ullage space that is defined by any space in the tank 12 not occupied by liquid or tank components.

The small engine fuel system 10 further includes a vent valve 22 disposed therein, where the vent valve 22 is in fluid communication with the tank 12. In an embodiment, the vent valve 22 is a rollover vapor vent valve. It is to be understood, however, that any valve capable of venting vapor in a fuel system may also suitably be used as the vent valve 22. The vent valve 22 substantially regulates the flow of any vapors from the tank 12 to, for example, a vapor retention device 54 (schematically shown in FIG. 1). In a non-limiting example, and as shown in FIG. 1, the vent valve 22 is disposed in the tank 12 such that the vent valve 22 is positioned within the ullage space of the tank 12 and a bottom surface 23 of the vent valve 22 is suspended substantially above the liquid fill level L.

In an embodiment, the vent valve 22 includes at least one flow passage (not shown), where the flow passage(s) remain open during operation of the small engine fuel system 10, during refilling of the tank 12, and/or combinations thereof. Meanwhile, the liquid portion of the fluid remains at or below the liquid fill level L. It is to be understood that as long as the liquid portion of the fluid does not contact the vent valve 22, the fluid passage(s) of the vent valve 22 will remain open. Thus, the fluid passage(s) are open during substantially normal operating conditions of the fuel system 10 (i.e., during substantially normal and conventional use, during an idle state, or when the system 10 is turned off). When the flow passage(s) are open, the vapors in the ullage space of the tank 12 may flow through the flow passage(s) of the vent valve 22 and to a component exterior to the tank 12, such as, for example, the vapor retention device 54.

In some instances, the small engine fuel system 10 may be operated under substantially rough operating conditions (e.g., when operating through rough terrain, when operating on a steep hill, when the system 10 is tipped beyond a predetermined angle, and/or the like). Such conditions may cause the liquid portion of the fluid in the tank 12 to splash or otherwise slosh within the tank 12. Under these conditions, the liquid level inside the tank 12 may rise above the liquid fill level L and contact the vapor vent valve 22. In these situations, the flow passage(s) of the vent valve 22 close, thereby substantially preventing any liquid or vapor from flowing through the vent valve 22. Furthermore, the closed fluid passage(s) substantially prevents any possible contamination of the vapor retention device 54 by the liquid fluid.

The small engine fuel system 10 also includes a spring valve 26 arranged in series with the vent valve 22 and in fluid communication therewith. The spring valve 26 regulates the flow of the fluid to and from the vent valve 22. FIG. 1 depicts the spring valve 26 located inside the tank 12. It is to be understood, however, that the spring valve 26 may also be located outside the tank 12. In still another embodiment, a portion of the spring valve 26 is disposed inside the tank 12 while another portion of the spring valve 26 is disposed outside the tank 12.

With reference now to FIGS. 2-4, the spring valve 26 generally includes a piston 28 operatively connected to a cartridge 30, where the cartridge 30 includes first and second portions 50, 52. In an embodiment, the piston 28 is at least partially disposed in the cartridge 30 and a seal 31 is formed therebetween. Non-limiting examples of suitable seals 31 include elastomeric seals, polymeric seals, metallurgical seals, and/or combinations thereof. The seal 31 may be attached to the piston 28, attached to the cartridge 30, or may be loosely constrained between the piston 28 and the cartridge 30.

A low-flow fluid passage 32 is formed in the piston 28, and includes a valve seat 40 and a movable valve member 42 disposed therein. The movable valve member 42 is positioned adjacent to the valve seat 40. In a non-limiting example, the movable valve member 42 is a relatively light-weight spherical member or ball that is configured to sit or otherwise be positioned against the valve seat 40 in response to a pressure difference across the spring valve 26 (which will be described further below). The movable valve member 42 is also diametrically large enough to block the low-flow fluid passage 32 when the movable valve member 42 is seated against the valve seat 40. When the movable valve member 42 blocks the low-flow fluid passage 32, the low-flow fluid passage 32 is substantially sealed.

The spring valve 26 also includes a high-flow fluid passage 34 that is defined by a space formed between an outer surface 36 of the piston 28 and an inner surface 38 of the cartridge 30. The high-flow fluid passage 34 may be closed by movement of the piston 28 inside the cartridge 30. The piston 28 is generally moved in response to the movement of a spring 44 disposed in the cartridge 30 and positioned adjacent to the piston 28. The spring 44 moves the piston 28 so that the piston 28 contacts the cartridge 30 and substantially seals the high-flow fluid passage 34. In an embodiment, the spring 44 is configured to bias the piston 28 so that the piston 28 contacts the cartridge 30 to close and seal the high-flow fluid passage 34 up to a threshold pressure. In a non-limiting example, the threshold pressure is determined by preloading the spring 44 with a force substantially equal to a predetermined threshold pressure multiplied by an effective area of the piston 28. It is to be understood that the effective area of the piston 28 is the area acted upon by the pressure.

The spring valve 26 is connected to the vent valve 22 via a first port 46, which may generally be fluid-tight. The first port 46 allows fluid communication between the vent valve 22 and the high-flow and low-flow fluid passages 32, 34. The spring valve 26 also includes a second port 48 for generally fluid tight connection with the vapor retention device 54 (shown in FIG. 1), an engine 56 (shown in FIG. 1), and/or combinations thereof. The second port 48 allows fluid communication between the low-flow and high-flow fluid passages 32, 34 and the vapor retention device 54 and/or the engine 56.

FIGS. 2-4 depict the spring valve 26 during several modes of operation of the small engine fuel system 10. FIG. 2 depicts a vacuum condition of the small engine fuel system 10, where the pressure of the fluid at the first port 46 (i.e., from inside the tank 12) is less than the pressure of the atmosphere at the second port 48. In this mode of operation, the lower pressure of the fluid at the first port 46 causes the movable valve member 42 to move away from the valve seat 40, thereby opening the low-flow fluid passage 32 and allowing vapor from the atmosphere (the flow path of which is referenced by the V_{A} in FIG. 2) of the fluid to pass through. At the same time, the high-flow fluid passage 34 remains sealed since the pressure at the first port 46 is also substantially lower than the threshold pressure of the spring 44. Thus, the spring 44 does not compress, and the piston 28 remains against the cartridge 30.

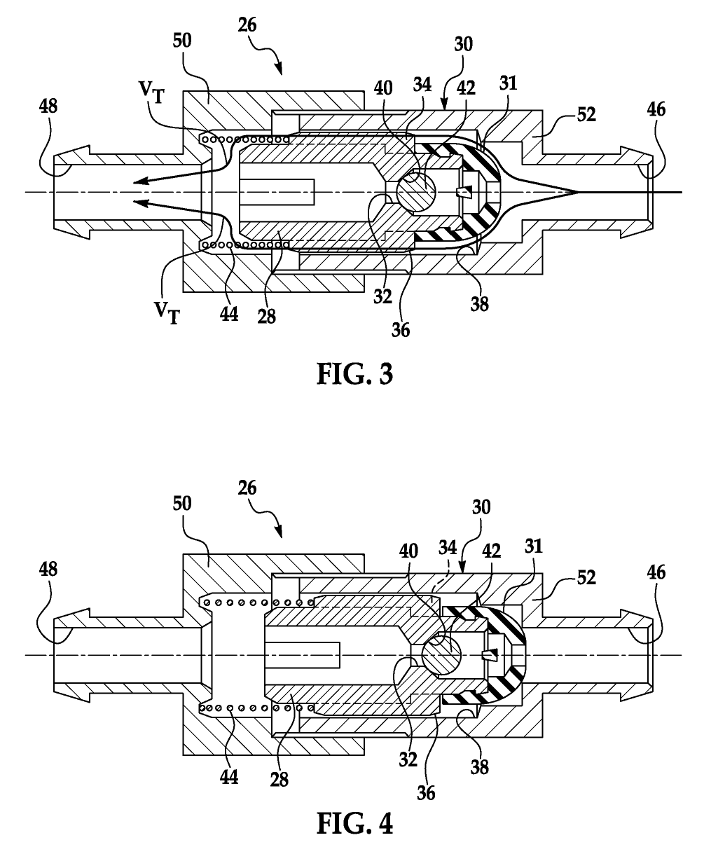

FIG. 3 depicts the spring valve 26 during a substantially normal operating condition of the fuel system 10. In this mode of operation, the pressure of the fluid at the first port 46 is higher than the pressure of the atmosphere at the second port 48. Even though the pressure is higher at the first port 46, if the pressure difference between the first port 46 and the second port 48 is higher than the threshold pressure, the piston 28 moves away from the cartridge 30 and compresses the spring 44, thereby opening the high-flow fluid passage 34 and allowing the vapor portion of the fluid (the flow path of which is referenced by V_{T} in FIG. 3) from the tank 12 to flow through. The low-flow fluid passage 32, however, remains substantially sealed as the movable valve member 42 moves against the valve seat 40.

FIG. 4 depicts the spring valve 26 during a refilling event. In this mode of operation, the pressure of the fluid at the first port 46 is higher than the pressure of the atmosphere at the second port 48, however, the pressure difference between the two is less than or equal to the threshold pressure. The low-flow fluid passage 32 is substantially sealed as the movable valve member 42 moves against the valve seat 40. The high-flow fluid passage 34 is also substantially sealed because the pressure difference between the fluid pressure at the first port 46 and the pressure of the atmosphere at the second port 48 does not exceed the threshold pressure. Thus, the spring 44 continues to bias the piston 28 against the cartridge 30. It is to be understood that, since the low-flow fluid passage 32 is closed during the refilling event, fluid cannot flow from the vent valve 22 and through the spring valve 26 after the level of the liquid reaches the liquid fill level L. At least in part because the threshold pressure is greater than a maximum liquid column pressure that can be created by completely filling the filler pipe 14, the spring valve 26 remains closed during the refilling event when the liquid level covers the lower portion 20 of the filler pipe 14. This generally prevents additional fluid from being added to the tank 12, thereby preventing overfilling of the tank 12 during the refilling event.

Also disclosed herein is a method of preventing overfilling of the fluid tank 12 for the small engine fuel system 10. The method includes providing the small engine fuel system 10, and substantially sealing the low-flow and the high-flow fluid passages 34, 36 of the spring valve 26 when the pressure of the fluid at the first port 46 is higher than the substantially atmospheric pressure at the second port 48 by a pressure difference that is less than or equal to the threshold pressure, thereby substantially preventing overfilling of the tank 12 during the refilling event.

In an embodiment, the refilling event may include a free fill, where the rate of refilling is not restricted by the small engine fuel system 10. In a non-limiting example, the rate of free filling ranges from about 1 gpm to about 20 gpm. In another embodiment, the refilling event may include a trickle fill, where the refilling rate is substantially slower than the rate for the free fill. In a non-limiting example, the rate of trickle filling ranges from about 0.25 gpm to about 1 gpm. It is to be understood that the fuel system 10 may be configured for free filling of the fluid, trickle filling of the fluid, and/or combinations thereof.

It is also to be understood that prior to filling the tank 12 with fluid, the inside of the tank 12 may already be occupied by a liquid form of the fluid, a vapor form of the fluid, and/or other vapors. During a refilling event, the liquid fluid fills any space defined in the tank 12 located below the liquid fill level L, and any vapors inside the tank 12 occupy the ullage space defined in the tank 12. As more fluid is added to the tank 12 during the refilling event, the amount of the liquid inside of the tank 12 increases and displaces the vapors, if any, occupying the tank 12. Once the level of the liquid fluid reaches the liquid fill level L, additional fluid introduced inside the tank 12 through the filler pipe 14 may well up in the filler pipe 14 and may potentially spill out of the upper portion 18 of the filler pipe 14 if the filler pipe 14 is overfilled.

It is to be further understood that the vapors occupying the tank 12 may be vapors present in the tank 12 prior to refilling, or may be vapors mixed with or generated by the refilling fluid entering the tank 12. In some instances, the vapors may flow out of the tank 12 through the filler pipe 14 until the level of the liquid fluid present in the tank 12 reaches the liquid fill level L. Once the liquid fluid reaches the liquid fill level L, the lower portion 20 of the filler pipe 14 is covered by liquid and substantially prevents the flow of the vapors out of the tank 12 through the filler pipe 14. It is to be understood that after the lower portion 20 of the filler pipe 14 is covered by liquid, a vapor pressure in the ullage may be balanced by a pressure of a column of liquid in the filler pipe 14. An increase in a height of the column of liquid above the liquid fill level L may be a signal to the operator that the tank is full.

It is yet also to be understood that the term “connect/connected” and/or the like are broadly defined herein to encompass a variety of divergent connection arrangements and assembly techniques. These arrangements and techniques include, but are not limited to (1) the direct connection between one component and another component with no intervening components therebetween; and (2) the connection of one component and another component with one or more components therebetween, provided that the one component being “connect to”, the other component is somehow operatively connected to the other component (notwithstanding the presence of one or more additional components therebetween).

While several embodiments have been described in detail, it will be apparent to those skilled in the art that the disclosed embodiments may be modified and/or other embodiments may be possible. Therefore, the foregoing description is to be considered exemplary rather than limiting.

What is claimed is:

1. A small engine fuel system, comprising:
a vent valve configured to be disposed in a tank having at least a portion of a filler pipe disposed therein, the filler pipe including an upper portion configured to receive a fluid and a lower portion located at a predetermined depth in the tank, wherein the predetermined depth defines a liquid fill level of the tank; and
a spring valve arranged in series with the vent valve, wherein the spring valve is configured to close during a refilling event, thereby substantially preventing overfill of the tank with the fluid.

2. The small engine fuel system as defined in claim 1 wherein the spring valve includes:
a piston operatively connected to a cartridge, wherein:
a low-flow fluid passage is formed in the piston; and
a high-flow fluid passage is defined by a space formed between an outer surface of the piston and an inner surface of the cartridge;
a valve seat disposed in the low-flow fluid passage;
a movable valve member disposed in the low-flow fluid passage and positioned adjacent the valve seat, wherein the movable valve member is configured to substantially seal the low-flow fluid passage when the movable valve member contacts the valve seat; and
a spring disposed in the cartridge and positioned adjacent the piston, wherein the spring is configured to bias the piston such that the piston contacts the cartridge to thereby substantially seal the high-flow fluid passage.

3. The small engine fuel system as defined in claim 2 wherein the spring valve includes:
a first port in fluid communication with the low-flow fluid passage, the high-flow fluid passage, or combinations thereof, wherein the first port is also in fluid communication with the vent valve; and
a second port in fluid communication with the low-flow fluid passage, the high-flow fluid passage, or combinations thereof, wherein the second port is also in fluid communication with at least one of a vapor retention device or an engine.

4. The small engine fuel system as defined in claim 3 wherein the spring is configured to bias the piston so that the piston contacts the cartridge to substantially seal the high-flow fluid passage up to a threshold pressure.

5. The small engine fuel system as defined in claim 4 wherein the low-flow fluid passage is configured to be opened and the high-flow fluid passage is configured to be substantially sealed when a pressure of the fluid at the first port is less than a substantially atmospheric pressure at the second port.

6. The small engine fuel system as defined in claim 4 wherein the low-flow fluid passage is configured to be substantially sealed and the high-flow fluid passage is configured to be opened when the fluid pressure at the first port is higher than the substantially atmospheric pressure at the second port by a pressure difference that is greater than the threshold pressure.

7. The small engine fuel system as defined in claim 4 wherein the low-flow and the high-flow fluid passages are both configured to be substantially sealed when the fluid pressure at the first port is higher than the substantially atmospheric pressure at the second port by a pressure difference that is less than or equal to the threshold pressure, thereby substantially preventing overfilling of the tank during a refilling event.

8. The small engine fuel system as defined in claim 2, further comprising at least one of an elastomeric seal, a polymeric seal or a metallurgical seal disposed between the cartridge and the piston.

9. The small engine fuel system as defined in claim 1 wherein the refilling event includes free fill or trickle fill.

10. The small engine fuel system as defined in claim 1 wherein the spring valve is configured to be located inside the tank, outside the tank, or combinations thereof.

11. A method of making a small engine fuel tank system, comprising the step of:
arranging a spring valve in series with a vent valve configured to be disposed within a tank having at least a portion of a filler pipe defined therein, wherein the filler pipe includes an upper portion configured to receive a fluid and a lower portion located at a predetermined depth in the tank, wherein the predetermined depth defines a liquid fill level of the tank, and wherein the spring valve is configured to close during a refilling event, thereby substantially preventing overfill of the tank with the fluid.

12. The method as defined in claim 11 wherein the spring valve includes:
a piston operatively connected to a cartridge, wherein:
a low-flow fluid passage is formed in the piston; and
a high-flow fluid passage is defined by a space formed between an outer surface of the piston and an inner surface of the cartridge;
a valve seat disposed in the low-flow fluid passage;
a movable valve member disposed in the low-flow fluid passage and positioned adjacent the valve seat, wherein the movable valve member is configured to substantially seal the low-flow fluid passage when the movable valve member contacts the valve seat;
a spring disposed in the cartridge and positioned adjacent the piston, wherein the spring is configured to move the piston such that the piston contacts the cartridge to thereby substantially seal the high-flow fluid passage;
a first port in fluid communication with the low-flow fluid passage, the high-flow fluid passage, or combinations thereof, wherein the first port is also in fluid communication with the vent valve; and
a second port in fluid communication with the low-flow fluid passage, the high-flow fluid passage, or combinations thereof, wherein the second port is also in fluid communication with a vapor retention device, an engine, or combinations thereof.

13. The method as defined in claim 12 wherein the spring is configured to bias the piston so that the piston contacts the cartridge to substantially seal the high-flow fluid passage up to a threshold pressure.

14. The method as defined in claim 13 wherein the low-flow fluid passage is configured to be opened and the high-flow fluid passage is configured to be substantially sealed when the fluid pressure at the first port is less than the substantially atmospheric pressure at the second port.

15. The method as defined in claim 13 wherein the low-flow fluid passage is configured to be substantially sealed and the high-flow fluid passage is configured to be opened when the fluid pressure at the first port is higher than the substantially atmospheric pressure at the second port by a pressure difference that is greater than the threshold pressure.

16. The method as defined in claim 13 wherein the low-flow and the high-flow fluid passages are both configured to be substantially sealed when the fluid pressure at the first port is higher than the substantially atmospheric pressure at the second port by a pressure difference that is less than or equal to the threshold pressure, thereby substantially preventing overfilling of the tank during a refilling event.

17. The method as defined in claim 12, further comprising disposing the vent valve in the tank.

18. A method adapted to prevent overfilling of a fluid tank for a small engine fuel system, including:
a tank;
at least a portion of a filler pipe defined in the tank, the filler pipe including an upper portion configured to receive a fluid and a lower portion located at a predetermined depth in the tank, wherein the predetermined depth defines a liquid fill level of the tank;
a vent valve disposed within the tank; and
a spring valve arranged in series with the vent valve, the spring valve including:
a piston operatively connected to a cartridge, wherein:
a low-flow fluid passage is formed in the piston; and
a high-flow fluid passage is defined by a space formed between an outer surface of the piston and an inner surface of the cartridge;
a valve seat disposed in the low-flow fluid passage;
a movable valve member disposed in the low-flow fluid passage and positioned adjacent the valve seat, wherein the movable valve member is configured to substantially seal the low-flow fluid passage when the movable valve member contacts the valve seat;
a spring disposed in the cartridge and positioned adjacent the piston, wherein the spring is configured to move the piston such that the piston contacts the cartridge to thereby substantially seal the high-flow fluid passage;
a first port in fluid communication with the low-flow fluid passage, the high fluid flow passage, or combinations thereof, wherein the first port is also in fluid communication with the vent valve; and
a second port in fluid communication with the low-flow fluid passage, the high-flow fluid passage, or combinations thereof, wherein the second port is also in fluid communication with a vapor retention device, an engine, or combinations thereof, the method comprising the step of:
substantially sealing the low-flow and the high-flow fluid passages when a pressure of the fluid at the first port is higher than a substantially atmospheric pressure at the second port by a pressure difference that is less than or equal to a threshold pressure, thereby substantially preventing overfilling of the tank during the refilling event.

19. The method as defined in claim 18, further comprising substantially sealing the high-flow fluid passage and opening the low-flow fluid passage when a pressure of the fluid at the first port is less than a substantially atmospheric pressure at the second port.

20. The method as defined in claim 18, further comprising substantially sealing the flow-flow fluid passage and opening the high-flow fluid passage when the fluid pressure at the first port is higher than the substantially atmospheric pressure at the second port by a pressure difference that is greater than the threshold pressure.

21. The method as defined in claim 18 wherein the threshold pressure is defined by a pressure to which the spring biases the piston so that the piston contacts the cartridge to substantially seal the high-flow fluid passage.
